(19) United States
(12) Patent Application Publication
(10) Pub. No.: US 2025/0312800 A1
(43) Pub. Date: Oct. 9, 2025

(54) MEAT GRINDER

(71) Applicant: Tzung-Han Wu, Tainan City (TW)

(72) Inventor: Tzung-Han Wu, Tainan City (TW)

(21) Appl. No.: 19/009,450

(22) Filed: Jan. 3, 2025

(30) Foreign Application Priority Data
Apr. 7, 2024 (CN) 202420699413.2
Apr. 29, 2024 (TW) 113204300

(51) Int. Cl. B02C 18/10

(52) U.S. Cl. CPC B02C 18/10

(57) ABSTRACT

A meat grinder is direct to a pivotal connection between the bottom end of the blade stand and the internal bottom surface of the grinding bowl, wherein a protruding piece is configured on one of them and a shallow recess is configured on the other one, and via embedding the protruding piece into the recess, the bottom end of the cutter frame is supported. Moreover, on the corresponding shaft end where the protruding piece is embedded with the recess, one is configured with a metal component, the other one is configured with a magnet or both are configured with a magnet, and therefore after the protruding piece is embedded with the recess, they are connected magnetically. Moreover, the magnetic connecting force is designed to enable the blade stand to rotate smoothly. Through the above configuration, the minced meat will not be left on the bottom end of the blade stand or inside the recess of the grinding bowl so the cleaning is convenient, thereby avoiding odor and food safety problems due to accumulation of meat scraps, while maintaining stable rotation of the blade stand.

### BACKGROUND OF THE INVENTION

The present invention relates to a meat grinder, and more particularly to a meat grinder with an improved design to avoid residue of minced meat on the bottom of the blade stand or inside recess of the grinding bowl so as to facilitate cleaning and avoid odor and food safety problems, while maintaining stable rotation of the cutter frame.

### DESCRIPTION OF THE RELATED ART

Accordingly, a conventional household meat grinder mainly comprises a main engine, wherein an electric motor is provided inside the mina engine and comprises a driving shaft; a grinding bowl comprises a bowl lip on the top end thereof, wherein a perforation is provided on the middle of the bowl lid; a blade stand comprises the grinder blades configured on the axial external wall of the blade stand, wherein the grinding blades are vertically disposed in the center of the grinding bowl, the top end is connected with the power output end of the driving shaft from the perforation, and the bottom end is connected to the center of the internal bottom surface of the grinding bowl. As shown in FIG. 1, the connection between the bottom end of the blade stand and the internal bottom surface of the grinding bowl is that the bottom surface of the blade stand 1 is concaved to form a pivot hole 10 with a depth, the internal bottom surface of the grinding bowl 2 is configured with an upward protruding pivot shaft 20, wherein the pivot shaft 20 is capable of being embedded into the pivot hole 10 to enable the bottom end of the blade stand 1 to be pivotally connected with the bottom end of the grinding bowl 2, thereby the bottom end of the blade stand 1 rotating stably inside the grinding bowl 2 due to the pivot relationship.

However, to maintain reliable pivot connection between the pivot hole 10 and the pivot shaft 20, the pivot hole 10 should have a vertical depth. Further, to ensure smooth rotation of the blade stand, a rotation gap should be provided between the pivot shaft 20 and the pivot hole 10. When operating the grinder, the minced meat will easily enter into the pivot hole 10 from the gap due to the deep of the pivot hole 10, and once the meat enters into the pivot hole 2, it will be very difficult to clean. If the machine is not properly cleaned, the residual minced meat will generate strong odor after some time and may cause food safety problems.

In view of the above shortcoming in the method for fixing the straight bars and cross bars of the pet guardrail, the inventor has made effort in improving the structure and finally produced the present invention.

### SUMMARY OF THE INVENTION

It is a primary objective of the present invention to provide a meat grinder that can avoid a residue of minced meat on the bottom end of the blade stand or inside recess of the grinding bowl, thereby avoiding odor and food safety problems due to convenient clean and maintaining stable rotation of the blade stand.

The primary feature of the present invention is related to the pivot connection between the bottom end of the blade stand and the internal bottom surface of the grinding bowl, a protruding piece is configured on one of them, a shallow recess is configured on another one and the bottom end of the blade stand is supported via embedding the protruding piece into the recess. Further, a metal component is configured on one of the corresponding shaft ends where the protruding piece is engaged with recess, a magnet is configured on the other end or a magnet is configured on both ends, thereby when the protruding piece is embedded into the recess, a magnetic connection is between them, and the magnetic connection is appropriately designed to ensure smooth rotation of the blade stand. Through the above configuration, the minced meat will not be left on the bottom end of the blade stand or inside the recess of the grinding bowl, and the machine can be cleaned easily, thus avoiding odor and food safety problems due to accumulation of meat scraps, and maintaining stable rotation of the grinding bowl.

For better understanding of the technical means to accomplish the above object and the effect of the present invention, detailed descriptions are provided below with respect to the following embodiment.

### BRIEF DESCRIPTION OF THE DRAWINGS

FIG. 1 is an exploded plane view of the conventional blade stand and grinding bowl.

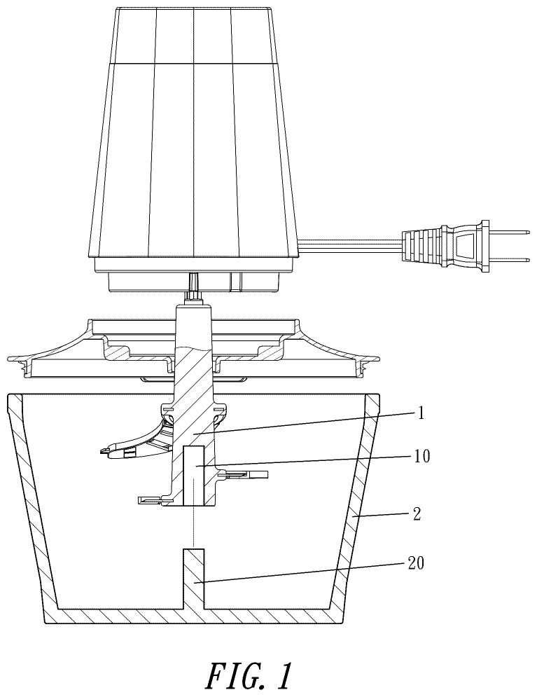

FIG. 2 is a combined perspective view of a preferred embodiment of the present invention.

FIG. 3 is an exploded perspective view (I) of a preferred embodiment of the present invention.

FIG. 4 is an exploded perspective view (II) of a preferred embodiment of the present invention.

FIG. 5 is a sectional perspective view of a preferred embodiment of the present invention.

FIG. 6 is a partial sectional plane view of a preferred embodiment of the present invention.

### DETAILED DESCRIPTION OF EMBODIMENTS OF THE INVENTION

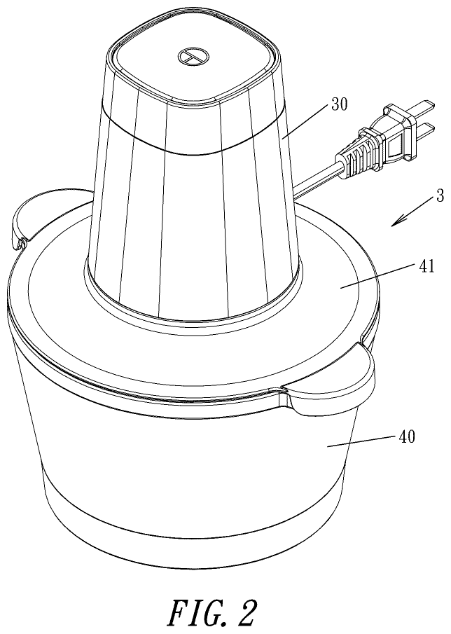

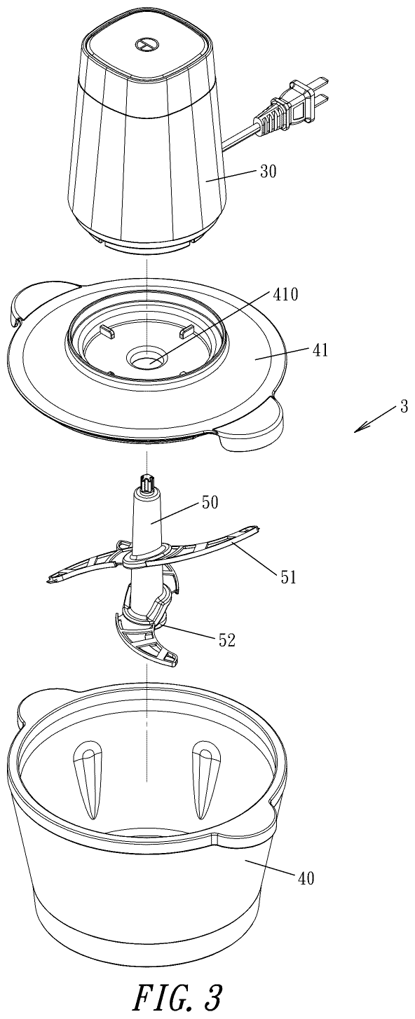

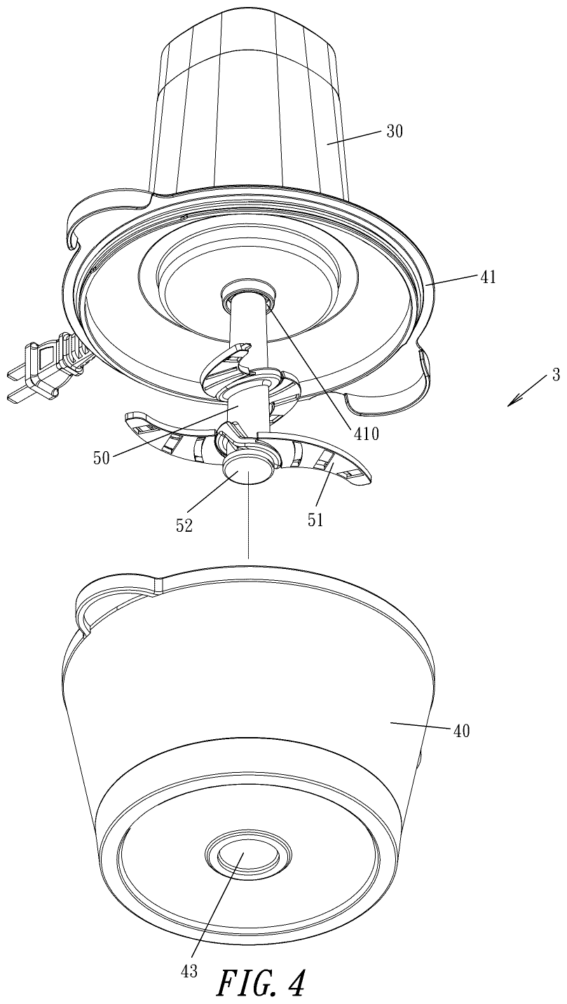

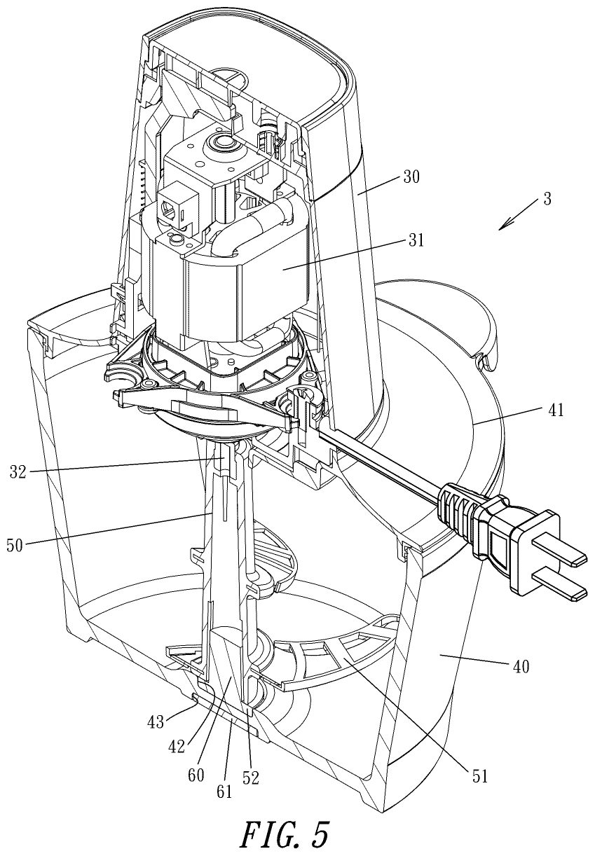

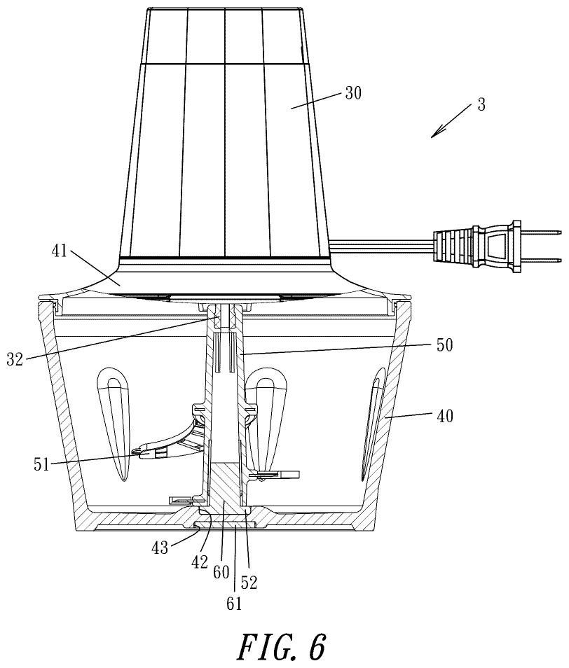

With reference to FIGS. 2 to 6, the meat grinder 3 of the present invention comprises:
a main engine 30 having an electric motor 31 mounted inside, a driving shaft of the motor 31 having a power output end 32 after the variable speed of a gear set (as shown in FIGS. 5 and 6);
a grinding bowl 40 having an interior for filling meat to be grinded, a top end of the grinding bowl 40 being covered by a bowl lid 41 and a perforation 410 being configured in the middle of the blow lid 41; and,
a blade stand 50 having the grinding blades configured on an axial wall of the blade stand 50, the blade stand 50 being vertically disposed in the center of the grinding bowl 40, the top end connecting with the power output end 32 of the motor 31 through the perforation 410 (as shown in FIGS. 3 and 4) and the bottom end connecting with the center of the internal bottom surface of the grinding bowl 40.

The primary improvement of the present invention is related to the connection between the bottom end of the blade stand 50 and the internal bottom surface of the grinding bowl 40. The bottom end of the blade stand 50 is configured with a protruding piece 52 protruding from the bottom end of the blade stand 50, the internal bottom surface of the grinding bowl 40 where corresponding to the protruding piece 52 is configured with a shallow recess 42 (as shown in FIGS. 5 and 6), the blade stand 50 is located inside the grinding bowl 40 and the protruding piece 52 can be embedded into the recess 42 to support the bottom end of the blade stand 50 (as shown in FIG. 6). Moreover, on the corresponding shaft ends where the protruding piece 52 is engaged with the recess 42, one of them is configured with a metal component 60 and the other one is configured with a magnet 61 or both are configured with a magnet. As shown in the figures of the present embodiment, the protruding piece 52 can be a metal component 60 made of metal material and the magnet 61 is fixed below the recess 42. The fixing manner of the magnet 61 is to install a holding slot 43 (as shown in FIGS. 4, 5 and 6) below the position of the bowl bottom of the grinding bowl 40 corresponding to the recess 42, wherein the holding slot 43 is capable of providing the magnet 61 to be placed in and fixed. When the protruding piece 52 is embedded with the recess 42, a magnetic connection exists between them, and the magnetic connection force is set up to enable the blade stand 50 to rotate smoothly via being driven by the power output end 32. The magnet 61 can also be fixed on the bottom end of the protruding piece 52 and a specifically designed smaller metal component 60 is fixed inside the holding slot 43. In this way, when the protruding piece 52 is embedded into the recess 42, they will have the effect of magnetic connection.

Further, the protruding piece 52 can also be configured on the internal bottom surface of the grinding blow 40 and the shallow recess 42 is configured on the bottom end of the blade stand 50, thereby the configuration also has the same effect of pivotal support.

Through the above-mentioned configuration, the present invention in application is that the bottom end of the blade stand 50 and the internal bottom surface of the grinding bowl 40 can be supported and connected pivotally due to the protruding piece 52 being embedded into the recess 42, and the protruding piece 52 and the recess 42 are embedded firmly due to a magnetic connection between the metal component 60 and the magnet 61, thereby enabling the blade stand 50 to rotate stably even though the recess 42 is a shallow design.

After the meat grinding is completed and the blade stand 50 is taken out for clean, the minced meat stick on the surface of the protruding piece 52 can be easily cleaned because the protruding piece 52 is in a convex shape, and because the recess 42 is shallow, even though the minced meat falls into the recess 42, it can also be cleaned easily.

As described above, in actual application, the present invention will at least have the following advantages and effects.
1. The minced meat can be cleaned conveniently and no residue accumulation, no odor, and no food safety problems are occurred.
2. The rotation of the blade stand remains stable.

In summary, the present invention not only has novelty, but also has value for industrial utilization. Therefore, an application for invention patent is submitted. Your examination and approval will be highly appreciated.

What is claimed is:

1. A meat grinder, comprising
a main engine having an electric motor configured inside, the motor driving a driving shaft to rotate;
a grinding bowl having a bowl lid covered on a top end thereof and a middle of the bowl lid having a perforation;
a blade stand being configured with the grinding blades on an axial outer wall, the blade stand being vertically disposed inside the grinding bowl, a top end being connected to a power output end of the driving shaft through the perforation and a bottom end being connected pivotally with an internal bottom surface of the grinding bowl, and wherein
a pivotal connection between the bottom end of the blade stand and the internal bottom surface of the grinding bowl being installed a protruding piece on one of them, a shallow recess being installed on the other one, the protruding piece being embedded into the recess to support the bottom end of blade stand, the corresponding shaft ends where the protruding piece and the recess being embedded mutually, one being configured with a metal component and the other one being configured with a magnet, thereby generating a magnetic connection after the protruding piece being embedded to the recess.

2. The meat grinder of claim 1, wherein the protruding piece is configured on the bottom end of the blade stand and the recess is configured on the internal bottom surface of the grinding bowl.

3. The meat grinder of claim 1, wherein the protruding piece is configured on internal bottom surface of the grinding bowl and the recess is configured on the bottom end of the blade stand.

4. The meat grinder of claim 1, wherein the metal component is configured on the protruding piece, the magnet is configured and fixed inside a holding slot provided on the bottom of the grinding bowl corresponding to a below of the recess.

5. The meat grinder of claim 1, wherein the metal component is configured on the bottom surface of the grinding bowl and the magnet is configured on the bottom end of the protruding piece.

6. A meat grinder, comprising
a main engine having an electric motor configured inside, the motor driving a driving shaft to rotate;
a grinding bowl having a bowl lid covered on the top end, wherein the bowl lid having a perforation in the middle;
a blade stand being configured with the grinding blades on the axial outer wall, the blade stand being vertically disposed inside the grinding bowl, the top end being connected to the power output end of the driving shaft through the perforation and the bottom end being pivotally connected with the internal bottom surface of the grinding bowl; and wherein
a pivotal connection between the bottom end of the cutter frame and the internal bottom surface of the mincer cup is to configure a protruding piece on one of them and a shallow recess on the other one so the protruding piece is embedded to the recess and supports the bottom end of the blade stand, and on the axial end where the protruding piece is pivoted inside the recess, both are configured with a magnet, so that they are magnetically connected after the protruding piece is embedded into the recess.
